(19) United States
(12) Patent Application Publication
(10) Pub. No.: US 2001/0029634 A1
(43) Pub. Date: Oct. 18, 2001

(54) Tool for setting drop-in anchors

(76) Inventor: Andre Lamarre, Mississauga (CA)

Correspondence Address: BERNSTEIN & ASSOCIATES, P.C., 6600 Peachtree Dunwoody Road, N.E., Suite 495, Embassy Row 400, Atlanta, GA, 30328-1649, US

(21) Appl. No.: 09/782,014

(22) Filed: Feb. 12, 2001

(30) Foreign Application Priority Data
May 3, 1999 (CA) 2,270,805

(51) Int. Cl. B26B 11/00

(52) U.S. Cl. 7/158

(57) ABSTRACT

There is described a setting tool for setting anchors into holes formed in masonry comprising; a bit including a cutting portion for penetrating the masonry, a stem for gripping by a drill and an enlarged diameter collar portion between the cutting portion and the stem, and a hollow sleeve portion open at one end adapted to fit over the cutting portion of the bit so that the cutting portion is freely rotatable in the sleeve, the open end of the sleeve being adapted to abut against the collar portion for transmitting an impacting vibration from the drill to the sleeve portion; and an anchor setting portion extending axially from the end of the sleeve opposite to the open end thereof, the setting portion being adapted to engage temporarily an anchor to be set in the hole.

### CROSS-REFERENCE TO RELATED APPLICATIONS

This application claims priority from copending U.S. patent application Ser. No. 09/562,418, filed May 1, 2000, and Canada patent application No. 2,270, 805 issued May 3, 1999, the disclosures of both of which are incorporated herein.

### FIELD OF THE INVENTION

The present invention relates to a setting tool and more particularly to a tool useful to set drop-in anchors into a previously drilled hole in concrete, masonry or the like.

### BACKGROUND OF THE INVENTION

When connecting an object to a wall of concrete, masonry or similar composites, the usual method is to drill a hole into the concrete using the appropriate masonry bit connected preferably to a hammer drill. After the hole is completed, the drill is set down and the anchor is set into the hole using a hammer and a manual setting tool which can be anything from a dedicated punch to a piece of steel rod. Whatever means is chosen to set the anchor, time is involved in selecting and using a different tool or tools to complete the setting. Nor is the amount of labour insignificant. It can require seven to ten blows using a three pound hammer to properly set a drop-in anchor, and sometimes more.

### SUMMARY OF THE INVENTION

To obviate this problem, the applicant proposes the use of a setting tool that fits over the drill bit used to make the hole like a sleeve. The sleeve includes a smaller diameter portion extending from its end that is used to set the anchor. This is a fast and easy operation that avoids damage to the drill bit and speeds up the anchor setting process.

It is therefore an object of the present invention to provide a setting tool that obviates and mitigates from the disadvantages of the prior art.

In accordance then with the present invention there is provided a setting tool for setting anchors into holes formed in masonry comprising; a bit including a cutting portion for penetrating the masonry, a stem for gripping by a drill and an enlarged diameter collar portion between the cutting portion and the stem, and a hollow sleeve portion open at one end adapted to fit over said cutting portion of the bit so that the cutting portion is freely rotatable in said sleeve, said open end of said sleeve being adapted to abut against said collar portion for transmitting an impacting vibration from the drill to said sleeve portion; and an anchor setting portion extending axially from the end of said sleeve opposite to said open end thereof, said setting portion being adapted to engage temporarily an anchor to be set in said hole.

### BRIEF DESCRIPTION OF THE DRAWINGS

Preferred embodiments of the present invention will now be described in greater detail and will be better understood when read in conjunction with the following drawings in which:

FIG. 1 is a side elevational view of a modified masonry bit;

FIG. 2 is a side elevational, cross-sectional view of the sleeve portion of the present setting tool;

FIG. 3 is a side elevational; cross-sectional view of the sleeve of FIG. 2 installed on the bit of FIG. 1;

FIG. 4 is a side elevational view of the combination of FIG. 3 including an anchor being installed in a drilled hole; and,

FIG. 5 is a side elevational view of a further embodiment of the present setting tool.

### DETAILED DESCRIPTION OF THE PREFERRED EMBODIMENTS

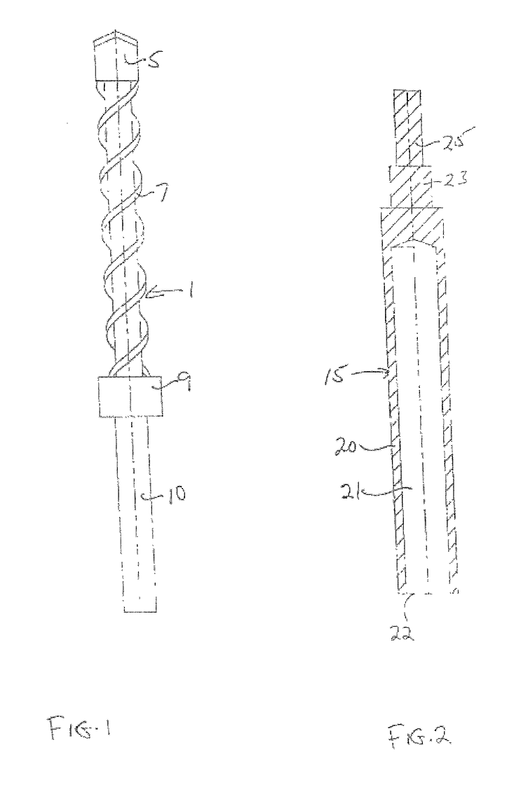

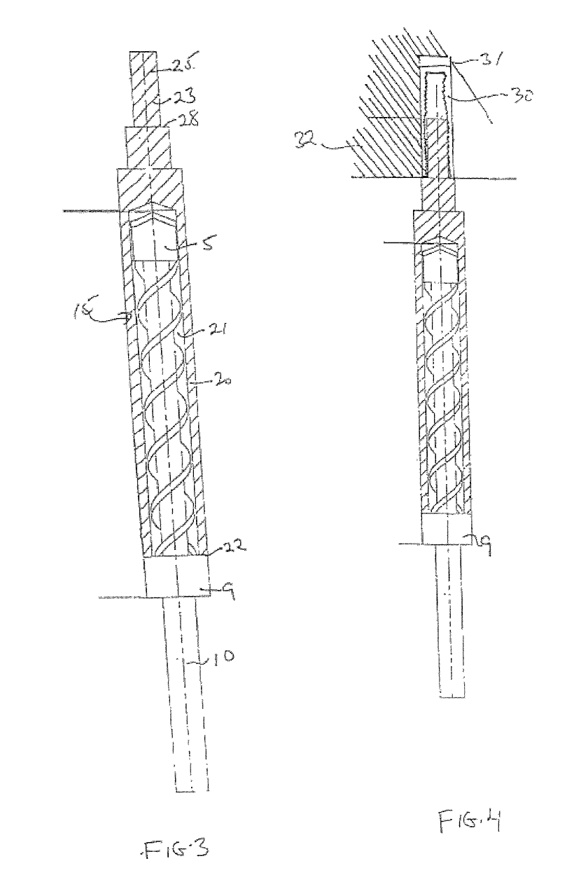

FIG. 1 shows an SDS masonry bit 1 including a cutting portion 5, drill flight 7, a stem 10 that fits into the chuck of a drill, preferably a hammer drill and which has been modified to additionally include an enlarged diameter collar 9 permanently connected to the bit such as by a weldment. As shown, collar 9 is a radially extending cylindrical flange. FIG. 2 shows the other portion of the present setting tool which is essentially a sleeve 15 including a hollow sleeve portion 20 with a hollowed out core 21 open at one end 22, a first axially extending portion 23 and a second axially extending portion 25. Portion 25 is preferably longer than portion 23 and has a smaller diameter.

With reference to FIG. 3, sleeve 15 in use fits over the bit as shown. The diameter of core 21 is slightly greater than the diameter of the bit and particularly cutting portion 5 so that the bit can freely rotate inside the sleeve. End 22 of the sleeve abuts against collar 9 to limit the penetration of the bit into the sleeve and as will be seen, the hollow core is slightly longer than the bit so that cutting portion 5 can rotate without actually drilling into the sleeve. The bit of course remains connected to the hammer drill.

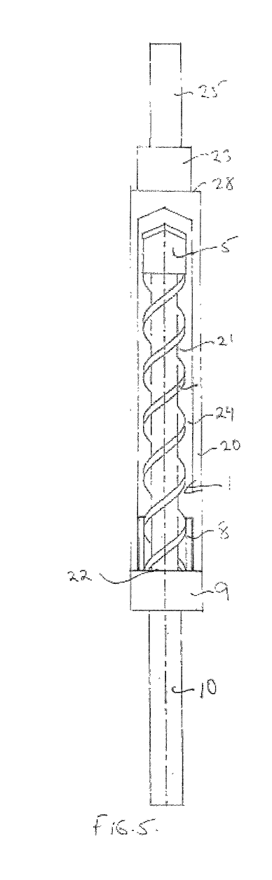

With reference to FIG. 4, in use, an anchor 30 will normally be placed over portion 25 and will abut against shoulder 28 between portions 23 and 25. The bit remains attached to the drill and the anchor 30 is aligned with a hole 31 in wall 32 and the drill is actuated. The drill's hammering effect will be transmitted to the anchor via the abutment between sleeve 20 and collar 9 to drive the anchor into the hole. The sleeve can then be removed and the next hole drilled, or a series of holes can be drilled and the sleeve then attached over the bit to set a corresponding number of anchors. Setting an anchor this way can take as little as two to three seconds.

A sleeve can be provided for each size of masonry bit used for correspondingly sized anchors.

In one embodiment constructed by the applicant, the outer diameter of cutting portion 5 is 0.525 inch, and the inner diameter of hollow core 21 is 0.545 inch. Clearance between the end of cutting portion 5 and the end of the core is 0.015 inch. The outer diameter of collar 9 is 0.750 inch which is the same as the outer diameter of sleeve 20. The diameter of portion 23 is 0.315 inch and the diameter of portion 25 is 0.500 inch.

In another embodiment contemplated by the applicant, collar 9 is eliminated and the sleeve can abut directly against the drill or the drill's chuck. However, it would be necessary to ensure that the bit is fully and properly inserted into the drill and to verify the length of the bit relative to the length of core 21 to ensure no damaging contact between the end of cutting portion 5 and the opposed end surface of core 21.

Reference will now be made to FIG. 5 showing a modification to the present tool and wherein like reference numerals have been used to identify like elements. As shown in FIG. 5, drill bit 1 includes a collar 9 modified to include an axially extending cylindrical shank 8 formed integrally with or welded to collar 9. Shank 8, which in one embodiment constructed by the applicant is approximately 0.500 inch in axial length, fits concentrically around the adjacent chill flight 7 and concentrically into end 22 of sleeve 20. Shank 8 thus centers bit 1 inside core 21, creating and maintaining an annular space 24 between drill flight 7 and cutting portion 5 of the drill bit and the inner surface of the sleeve. The shank therefore aligns the bit properly inside the sleeve while the sleeve is being used to set the anchor, and limits contact between cutting portion 5 and drill flight 7 and the core's inner surfaces to limit rubbing and wear on the bit. Anchors normally fit into the drilled holes with very close tolerances. As the bit wears, it becomes increasingly difficult to partially insert the anchor into the hole by hand without using a hammer, and one of the objects of the present tool is to eliminate the need for a hammer from the overall process. It has therefore been found that shank 8 significantly reduces contact between the bit and the sleeve's inner surfaces, which prolongs the bit's useful life and which permits many more holes to be drilled using the same bit before the bit goes off tolerance.

It will be appreciated as well that instead of providing a modified bit and a removable sleeve portion to be used in combination, the present tool can be a unitary piece consisting essentially of sleeve 15, hollow or solid, and stem 10 permanently connected together. A bit would be used to make a series of holes and would then be replaced with the unitary setting tool to set the anchors.

The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following appended claims. All patents, application, and publications referred to are incorporated by reference in their entirety herein.

Claimed is:

1. A setting tool for setting anchors into holes formed in masonry comprising; a bit including a cutting portion for penetrating the masonry, a stem for gripping by a drill and an enlarged diameter collar portion permanently connected between the cutting portion and the stem, and a hollow sleeve portion open at one end adapted to fit over said cutting portion of the bit so that the cutting portion is freely rotatable in said sleeve, said open end of said sleeve being adapted to abut against said collar portion for transmitting an impacting vibration from the drill to said sleeve portion; and an anchor setting portion extending axially from the end of said sleeve opposite to said open end thereof, said setting portion being adapted to engage temporarily an anchor to be set in said hole.

2. The setting tool of claim 1, wherein said collar portion comprises a radially extending flange portion and a cylindrical shank extending axially therefrom, said shank being sized to fit concentrically into said open end of said hollow sleeve to create and maintain an annular space between said cutting portion of said bit and the interior surfaces of said sleeve.

3. The setting tool of claim 2, wherein said anchor setting portion includes first and second axially aligned cylindrical portions, said first portion being smaller in diameter than said second portion with a shoulder defined between said first and second portions, said first portion being sized to concentrically fit into said anchor and said shoulder being sized to abut against an end of said anchor for transmitting said impacting vibration from said drill.

4. A method of setting anchors into holes formed in masonry, comprising the steps of:
forming a hole in masonry for an anchor using a rotatable bit, the bit having an enlarged diameter portion thereon defining a circumferentially extending collar and a cylindrical shank extending axially therefrom;
placing a sleeve on said bit, said sleeve having a hollow interior allowing said bit to rotate freely therein, an end of said sleeve being adapted to fit around said shank and to abut against said collar and the other end of said sleeve being adapted to abut against the anchor to be set in the hole; and
imparting an anchor setting force through said collar to said sleeve and then to said anchor.
